(19) United States
(12) Patent Application Publication
(10) Pub. No.: US 2016/0034822 A1
(43) Pub. Date: Feb. 4, 2016

(54) METHOD FOR INFERRING STANDARDIZED HUMAN-COMPUTER INTERFACE USAGE STRATEGIES FROM SOFTWARE INSTRUMENTATION AND DYNAMIC PROBABILISTIC MODELING

(71) Applicant: The Charles Stark Draper Laboratory, Inc., Cambridge, MA (US)

(72) Inventors: Laura Mariano, Watertown, MA (US); Joshua Poore, Somerville, MA (US); Jana Schwartz, Somerville, MA (US); William Coskren, North Reading, MA (US)

(21) Appl. No.: 14/815,510

(22) Filed: Jul. 31, 2015

Related U.S. Application Data
(60) Provisional application No. 62/031,659, filed on Jul. 31, 2014.

(51) Int. Cl. G06N 7/00

(52) U.S. Cl. CPC G06N 7/005

(57) ABSTRACT

A user interface analysis system and method can provide aggregate information across a population of users of the user interface. The system includes an activity logging module, an analysis module, and a reporting module. The analysis module is configured to generate an analysis model descriptive of the user interface usage of the plurality of users. The analysis model can take the form of a beta-phase Hidden Markov Model (“BP-HMM”). The reporting module processes the generated analysis model and outputs data indicative of an aggregate of the plurality of users' usage of the user interface.

### RELATED APPLICATION

This application claims priority to U.S. Provisional Patent Application No. 62/031,659 filed on Jul. 31, 2014 and titled “METHOD FOR INFERRING STANDARDIZED HUMAN-COMPUTER INTERFACE USAGE STRATEGIES FROM SOFTWARE INSTRUMENTATION AND DYNAMIC PROBABILISTIC MODELING,” which is herein incorporated by reference in its entirety.

### BACKGROUND OF THE DISCLOSURE

Computer graphical interfaces are growing ever more complex, making it difficult for users to learn the software. Similarly, it is difficult for developers to gather quantitative metrics about how users are interacting with the graphical interfaces.

### SUMMARY OF THE DISCLOSURE

The present disclosure discusses a system and method for inferring software usage strategies. The quantitative measurement of a user's strategy for interfacing with a graphical interface enables discovery of how the software is used and how proficient the user is with the software. For a group of users, the quantitative measurement of each of the user's interactions with the graphical interface enables assessment of performance within and between individuals. Analysis of the aggregate of interactions with a piece of software across a range of users enables analysis of overall usability of the software and a comparison of the usability of the user interface of that software with that of other pieces of software.

In some implementations, the disclosed system generates data that is fed back into the software the user is interfacing with. Based on the system's analysis of the user's usage strategies, the software actively adapts its interface based on the user's current needs or proficiency levels.

According to one aspect of the disclosure, a system for analyzing user interface usage characteristics includes an activity logging module. The activity logging module is configured to store a log of a user-initiated software activity instances that are associated with usage of a user interface of a software application by a plurality of users. The system also includes an analysis module. The analysis module is configured to generate an analysis model that is descriptive of the user interface usage of the plurality of users. The analysis model includes a beta-phase Hidden Markov Model (“BP-HMM”). The system also includes a reporting module that is configured to process the generated analysis model and output data that is indicative of an aggregate of the plurality of users' usage of the user interface.

In some implementations, the analysis module is configured to generate the analysis model by selecting a plurality of model parameter value sets, generating candidate BP-HMMs for each model parameter value set, and selecting one of the candidate BP-HMMs as the analysis model.

In some implementations, selecting one of the candidate BP-HMMs includes grouping the candidate BP-HMMs into a plurality of groups, then identifying one candidate model from each of the groups as a finalist model, and selecting one finalist model as the analysis model. In some implementations, selecting the finalist model as the analysis model includes identifying a finalist model, of the finalist models that lack a junk state, that has the most states. In some implementations, the values for at least one parameter in the model parameter value sets are selected at random.

In some implementations, the analysis module is also configured to compare a specific user's user interface usage patterns to the analysis model or to a library of usage patterns that are extracted from the analysis model. The usage patterns are indicative of inefficient user interface usage. In some implementations, the reporting module is further configured, in response to the the above comparison, to alter the complexity of the specific user's user interface to the software application. The reporting module can also be configured, in response to the above comparison, to output to the specific user a prompt that is indicative of more efficient user interface usage strategies.

According to another aspect of the disclosure, a method for analyzing user interface usage characteristics storing a log of user-initiated software activity instances. The activity instances are associated with usage of a user interface of a software application by a plurality of users. The method also includes generating an analysis model descriptive of the user interface usage of the plurality of users. The analysis model includes a beta-phase Hidden Markov Model (“BP-HMM”).

In some implementations, generating the analysis model also includes selecting a plurality of model parameter value sets, generating candidate BP-HMMs for each model parameter value set, and selecting one of the candidate BP-HMMs as the analysis model.

In some implementations, selecting one of the candidate BP-HMMs also includes grouping the candidate BP-HMMs into a plurality of groups, identifying one candidate model from each of the groups as a finalist model, and selecting one finalist model as the analysis model. Selecting the finalist model as the analysis model can include identifying a finalist model, of the finalist models that lack a junk state, that has the most states.

In some implementations, the method includes comparing a specific user's user interface usage patterns to the analysis model or to a library of usage patterns extracted from the analysis model. The extracted usage patterns are indicative of inefficient user interface usage. In some implementations, the method includes, in response to the above comparison, altering the complexity of the specific user's user interface to the software application. In some implementations, in response to the above comparison, the method includes outputting to the specific user a prompt indicative of more efficient user interface usage strategies.

According to another aspect of the disclosure a non-transitory computer readable storage medium stores processor executable instructions. The processor executable instructions are for storing a log of user-initiated software activity instances associated with usage of a user interface of a software application by a plurality of users. The instructions are also for generating an analysis model descriptive of the user interface usage of the plurality of users. The analysis model comprises a beta-phase Hidden Markov Model (“BP-HMM”). The instructions are also for processing the generated analysis model, and outputting data indicative of an aggregate of the plurality of users' usage of the user interface.

In some implementations, the computer readable storage medium also stores instructions for generating the analysis model by selecting a plurality of model parameter value sets, generating candidate BP-HMMs for each model parameter value set, and selecting one of the candidate BP-HMMs as the analysis model.

In some implementations, the computer readable storage medium also stores instructions for selecting one of the candidate BP-HMMs by grouping the candidate BP-HMMs into a plurality of groups, identifying one candidate model from each of the groups as a finalist model, and selecting one finalist model as the analysis model.

In some implementations, the computer readable storage medium also stores instructions for selecting the finalist model as the analysis model by identifying a finalist model, of the finalist models that lack a junk state, that has the most states.

In some implementations, the computer readable storage medium also stores instructions for comparing a specific user's user interface usage patterns to the analysis model or to a library of usage patterns extracted from the analysis model. The usage patterns are indicative of inefficient user interface usage. In some implementations, the computer readable storage medium also stores instructions for, in response to the above comparison, altering the complexity of the specific user's user interface to the software application. In some implementations, the computer readable storage medium also stores instructions for, in response to the above comparison, outputting to the specific user a prompt indicative of more efficient user interface usage strategies.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 illustrates an example system for inferring human-computer interface usage strategies.

FIG. 2 is a block diagram of an example Beta-Process Hidden Markov Model (“BP-HMM”) analysis module suitable for use as the analysis module shown in FIG. 1.

FIG. 3 is a flow diagram of an example method for generating a BP-HMM that can be carried out by the BP-HMM analysis module.

FIG. 4 is a flow diagram of an example method of controlling user interface operation.

FIG. 5 is a flow diagram of another example method of controlling user interface operation.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As an overview, the system described herein provides for the generation of metrics for the analysis of how users, individually, or as a group, interface with software. For example, the system provides for the estimation of whether a user is proficient with a software tool, or whether the user is efficiently learning to use the software tool. The system also provides for the estimation of how the user, relative to a population, uniquely attempts to perform a software-assisted task and whether the tool impedes or augments the users' ability to perform that task.

The system can provide for the characterization of the overall usability of a piece of software through automated analysis of usage patterns across a population of users. Such information can be useful in providing objective comparisons between the usability of competing software packages designed to provide similar functionality.

The system can make use of user activities that are directly related to the performance of tasks for which the software is designed; specifically, tasks that involve cognition, problem solving, and user performance and are expected to vary between different users and sessions. This enables the system to take an estimation approach to user activity in human-computer interfaces, rather than assuming a 1:1 relationship between current activity and intent. By not assuming a 1:1 relationship between current activity and intent, the system enables users to make mistakes, use novel usage patterns, and express exploratory behavior while not detrimentally affecting the system's ability to model the user's behavior.

In some implementations, the system does not impose any a priori models on the way a user “should” interact with the software or specify a finite space of strategies or activity patterns. The actual modes of usage can be inferred from the data with minimal constraints. In some implementations, the system identifies common behaviors within and across users. The use of both frequentist approaches and ensembles of Hidden Markov models for modeling an entire corpus of behavioral sequences creates a standardized activity strategy-space that allows for comparisons both within and across individuals.

In some implementations, the system can analyze a user's strategy for using a software tool with limited prior training data. Both frequentist and Hidden Markov modeling are unsupervised learning algorithms, and do not require historical labeling of data for training The output of the models is statically analyzed to determine the degree to which usage strategies appear systematic or random in nature.

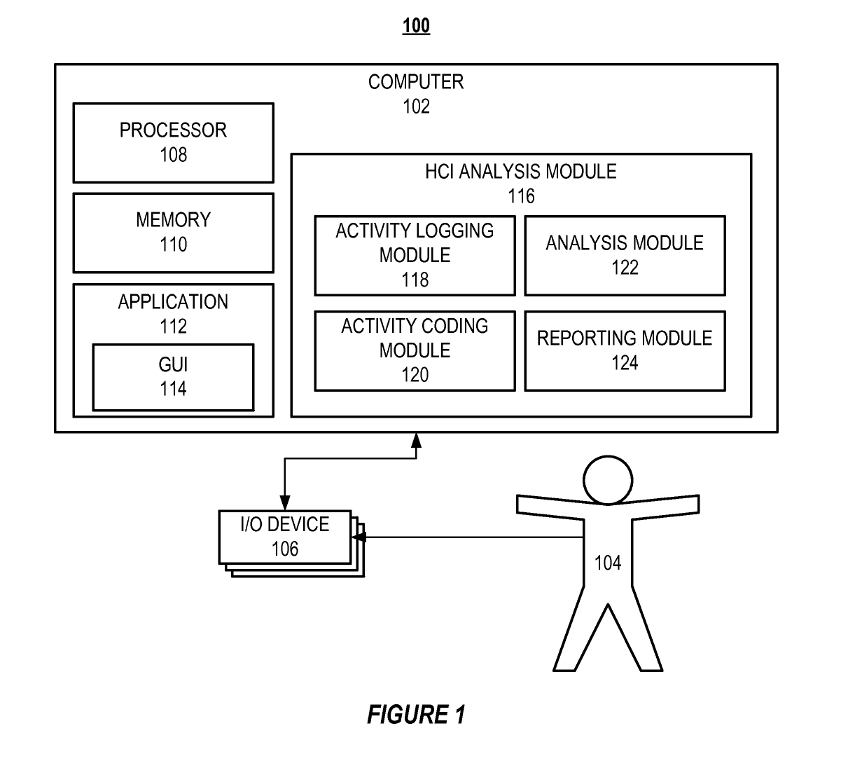

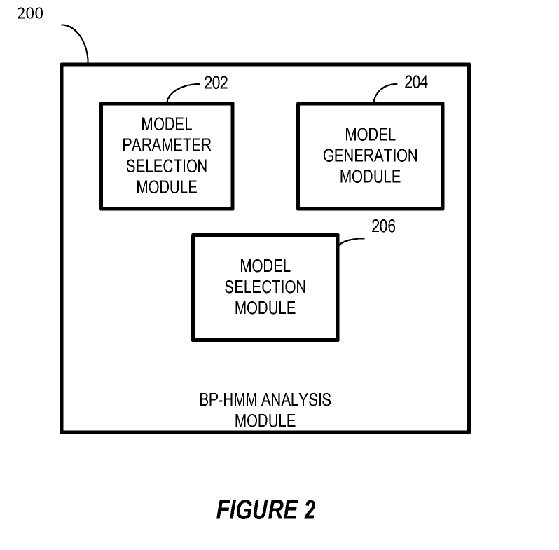

FIG. 1 illustrates an example system 100 for inferring human-computer interface usage strategies. The system 100 includes a computer 102. A user 104 interacts with the computer 102 through one or more input/output (I/O) devices 106. The computer includes a processor 108, which executes processor-executable instructions stored in a memory 110. Execution of the processor-executable instructions causes the computer 102 to perform the actions associated with an application 112. The application 112 includes a graphical user interface (GUI) 114 with which the user 104 interacts (through the I/O devices 106). The computer 102 also includes a human computer interface (HCI) analysis module 116. The HCI analysis module 116 includes an activity logging module 118. The HCI analysis module 116 also includes an activity coding module 120 to code (or categorize) the activities logged by the activity logging module 118. The HCI analysis module 116 also includes an analysis module 122 and a reporting module 124. In some implementations, one or more of the aforementioned modules are combined or integrated with one or more other of the modules. For example, the activity logging module 118 may be combined with the activity coding module 120. Similarly, in some implementations, one or more of the aforementioned modules may be further divided into multiple modules or sub-modules. For example, the analysis module 122 may be subdivided into multiple modules, as described further in relation to FIG. 2.

The computer 102 of system 100 includes the processor 108. The processor 108 is in electrical communication with the memory 110. The processor 108 is a single core or multicore processor and is configured to read data from and write data to the memory 110. The processor 108 is configured to execute processor-executable instructions stored in the memory 110, such as, but not limited to, applications, programs, libraries, scripts, services, processes, or any other type of processor-executable instructions. In some implementations, the memory 110 is a hard drive, solid-state drive, flash-drive, or other volatile or non-volatile memory.

The processor 108 of the computer is also configured to execute the processor-executable instructions of the application 112. The application 112 includes a GUI 114 that the user 104 interfaces with, via the I/O devices 106, to interact with the application 112 and perform the programmed tasks of the application 112. The user 104 interacts with the application 112 to achieve goals or perform software related tasks. For example, the application 112 may be a spreadsheet application, database application, web browser, computer-aided design (CAD) drafting application, video game, software development kit, or any other software application that the user 104 uses to manipulate and view data or perform tasks. The HCI analysis module 116 described herein is configurable to interface with any type of application 112 and the specifics of the application 112 are not of importance for the operation of the HCI analysis module 116. In the system 100, the user 104 interacts with the computer 102 through one or more I/O devices 106. The I/O devices 106 can include a mouse, track pad, touch screen, touch pad, drawing tablet, display monitor, microphone, keyboard, camera or other input device.

The system 100 also includes the HCI analysis module 116. The HCI analysis module 116 collects and analyzes the usage strategies of the user 104 as the user interfaces with the application 112. In some implementations, the HCI analysis module 116 can determine the individual user's performance with the application 112, the ease of use of the application 112, determines how well the user 104 is learning to use the application 112, or any combination thereof. In some other implementations, the HCI analysis module 116 determines aggregate usage patterns and usability metrics for a software application across a population of users.

The HCI analysis module 116 includes an activity logging module 118. The activity logging module 118 logs the user's interaction with the application 112 and generates time-stamped activity logs. In some implementations, the logs are automatically generated in real time as the user 104 uses the application 112. In other implementations, the logs are created post-hoc after the user 104 has completed a specific task or activity with the application 112. The activity logging module 118 logs user behaviors within the software environment, such as activation or selection of software functions (e.g., for interaction with a spreadsheet application, the behaviors may include button selections, mouse movements and positions, queries, application of filters, making of annotations, etc.) that are used to complete tasks. In some implementations, the HCI analysis module 116 can also capture screen recordings or screen shots of the user's interaction with the application 112.

In the example of evaluating usage with a spreadsheet application, the activity logging module 118 may log the location and time of each of the mouse clicks made by the user 104 as the user 104 performs a linear regression, or other task, on a dataset displayed by the spreadsheet application. The logged activity can also include non-task related activities such as cognitive operations. For example, a cognitive operation may include how the user 104 explores the application 112. In some implementations, the activities are linked to targets of the application 112. For example, the activity logging module 118 may monitor how often document files, profiles, data variables, or other media used by the application 112 is accessed.

In some other implementations, the activity logging module 118 is a generic tool, designed to be independent of the software application being monitored. In such implementations, the activity logging module 118 is configured to log, or extract from an existing or contemporaneously generated software activity log generated natively by the monitored software application, only those activities that were generated by user interaction. For example, software activity resulting from background system functionality, e.g., document auto-saves, data prefetching, spelling autocorrection, etc. is ignored or stricken from the log.

In some implementations, the activity logging module 118 collects the activity using middleware or an API. For example, using an API, the application 112 may relay usage of the application 112 extracted from software logs natively maintained by the application 112 to the HCI analysis module 116. In another implementation, the activity logging module 118 may interface directly with the memory 110 and I/O devices 106 to determine when the user makes data writes to the memory 110 and to log keystrokes and mouse clicks that are made by the user 104. One suitable API for the activity logging module is the User Activity Logging Engine (or User-ALE) provided by Charles Stark Draper Laboratory, headquartered in Cambridge, Mass.

The HCI analysis module 116 also includes an activity coding module 120. The activity coding module 120 categorizes, classifies, or otherwise labels each of the activities performed by the user 104 to differentiate self-same activities from different activities. The labels and categories may be in a code format (e.g., the mouse pointer is within a box h pixels by l pixels large, located at the screen location of (X, Y)) or by natural language (e.g., the user clicked the start button at time t). In some implementations, the coding is automated. The coding of user activity can occur in real-time or following the acquisition of the activity logs. In other implementations, the coding is performed manually or includes a manual review of a portion of the activities automatically coded by the activity coding module 120. In some implementations, activities are labeled or coded to indicate that the activity belongs to more than one category or to a hierarchically list of categories. For example, a recognized input from the mouse to open a menu may be categorized as a “menu” access under the broader category of “mouse click” which may be under the broader category of “user input.”

The HCI analysis module 116 also includes an analysis module 122. The analysis module analyzes the logged and coded activities of the user 104 or multiple users 104 to determine usage patterns. In some implementations, the analysis module 122 locates patterns within the data by modeling the data. The coded logs are input into a model used by the analysis module 122 as a time series of categorized variables. Example time series that can be generated from the activity logs can include a time series of categorical variables where each sample can correspond to the occurrence of a logged user behavior; a time series of continuous valued variables describing the rate at which the user performed the logged actions; a time series of joint categorical-continuous variables that simultaneously represents the logged behaviors and the rate at which the logged behavior is performed; or a combination thereof.

The analysis performed by the analysis module 122 includes statistical analysis of the data logs. In some implementations, the statistical analysis of the data logs includes a Frequentist approach and in other implementations the statistical analysis includes a Bayesian approach. In the Frequentist approach, statistical analysis of the frequency and occurrence of the coded behaviors across the whole time series and/or subportions of the whole time series are performed. The Frequentist analysis may include parametric or non-parametric modeling. The parametric approach is performed under the assumptions of statistical normality and that each activity's frequency or rate is expressible as a random variable. With the parametric approach, a probability distribution function is computed for each user's session with the interface for each unique activity across the entire time series and across a pre-specified or randomly-specified period of time. Analysis of Variance, Z- or Student's T-Tests (or others) may be used to test the likelihood that different probability density functions of the pre-specified or randomly-specified periods parametrically differ from those of the entire time series. Parametric analysis of the activities provides information regarding when, in time, transitions in interaction strategy become substantively different from the normal user interaction with the interface.

The non-parametric approaches of the analysis module 122 are performed under assumptions of “distribution-free” or “non-parametric” activity frequencies. In the non-parametric implementation coded activity counts are tabulated for each unique activity across the entire time series and across predetermined or randomly-specified shorter periods of time within the time series. Chi-Square tests (or other non-parametric, statistical tests) may be used to compare the model fit of the time series to determine when different user strategies emerge. Both parametric and non-parametric modeling strategies may be generalized across multiple human computer interaction sessions for the same user, or across different users, to identify common interaction strategies among the sessions.

Still referring to the analysis module 122 of system 100, in some implementations, the analysis module 122 uses a Bayesian approach to analyze the data logs. The data logs can include multiple time series associated with different interactions with the application. The collection of time series is referred to as an “ensemble.” One example of a Bayesian approach is to use Ensemble Hidden Markov Modeling (EHMMs) to analyze the data logs. An EHMM is a state-space model that characterizes the dynamics of a data sequence in terms of a discrete set of hidden states with Markovian state transition properties. The observations (data samples) are emitted by the hidden states, and the parameters governing these emissions are conditionally independent given the state. Using the sequence of coded logs as observations, an EHMM is fitted to each time series in the ensemble. The parameters describing the state-specific emission distributions and transition probabilities characterize the dynamics of the user's interaction with the interface of the application 112. The EHMM may be implemented with at least two different approaches for identifying patterns in the ensemble.

A first example approach for implementing an EHMM is to use Emission Parameter Clustering (EPC). In this approach, the observations generated by each hidden state are random variables with state-specific observation probability distributions. The form of the probability distribution is a function of the representation of the behavioral logs used to train the model. For example, state-specific probability distributions for the sequence of categorical variables are modeled as multinomials with parameters describing the relative frequency with which each of the logged behaviors was observed in each state. To identify common modes of behavior across time series of the interaction strategies, the parameters governing the state-specific emission distributions are clustered using a k-means algorithm. In this implementation, a HMM is fitted to each time series separately, and clustering is performed on the resulting set of emission parameters.

A second example approach for identifying patterns in a HMM is to use a Beta-Process HMM (BP-HMM). The BP-HMM algorithm is a Bayesian nonparametric approach for simultaneous modeling of related time series. Instead of modeling each time-series individually, and looking for shared patterns afterwards (as in the EPC method), the BP-HMM models the time-series as an ensemble, such that the time series share states with the same emission distribution parameters. This approach can also assume a potentially infinite state-space, and the optimal number of states describing the ensemble is inferred from the data. Further description of BP-HMM models and processes for generating such models can be found in “Sharing Features Among Dynamical Systems with Beta Processes,” by E. G. Fox et al., NIPS (Vancouver, BC), 2009, the entirety of which is incorporated herein by reference.

The analysis module 122 extracts the parameters used to generate the model and the output of the models to generate observed usage strategies. In some implementations, the output also includes the time spent within each of the observed strategies, composition of the strategies (e.g., frequencies of activities and state-specific emission distribution parameters), and the state-transition probability matrices for strategy shifts. These parameters may be used to build metrics that describe within-person/population or between person/population usage patterns, cognitive/behavioral states, develop “gold-standards” or comparison cases for usage, or descriptions of the interface. For example, transitions between usage strategies can provide information about the nature of the task the interface is designed to facilitate, how well the interface is designed, and the propensities of the user or user population. For example, if a user chaotically transitions between stages it may be an indication the user interface was poorly designed. In another example, non-parametric tests (e.g., Chi-Square) may be used to compare differences between states or patterns within or between users or user populations and may be used for significance testing in determining how well a user 104 or user population is learning to use the interface. Cluster analysis (e.g., K-Means) may be used to differentiate between strategies across users, and classify users relative to patterned usage groups. In another example, time spent within usage strategies and the likelihood of transition to other strategies provides information regarding the volatility of the state and whether a user has not yet discovered an effective usage strategy. By comparing these metrics against prior states, patterns of usage, or across other users, estimations of tool efficacy and user proficiency are possible.

Referring to FIG. 1, the HCI analysis module 116 also includes a reporting module 124. The reporting module 124 reports the conclusions of the analysis module to the users 104 or a developer of the application 112. The reporting module 124 may indicate if there are specific features of the application interface that the user (or users in general) finds difficult to use or the report may indicate the overall effectiveness of the interface. In another implementation, feedback from the reporting module 124 may indicate the user's or user population's overall proficiency with the application 112 or compare the strategies of the user 104 with the strategies of other users. For example, the BP-HMM modeling approach produces a standardized state-space of user behavior patterns. This state-space identifies how activities are probabilistically related to one another and offers a quantitative means for evaluating how users interact with the software to perform complex tasks that may require cognitive, analytical, and procedural strategies to complete. For example, BP-HMM modeling of activities logged from interaction with software designed to perform data analysis can reveal how discrete analytic operations (e.g. searches, examination, hypothesis testing, and data exploration) were utilized to complete an analysis task. The patterns of interaction with the software are encoded in the parameters of the BP-HMM, and analysis of these parameters reveals insight into how an individual's or user population's approach to the analysis task manifested in their use of the software. The reporting module 124 can also output data metrics extracted from the model, including the time each user spends in specific states, the kurtosis or distributional characteristics of each state, such as the rate with which each user transitions between states, and the likelihood that a given user will transition between one state or another

In some implementations, analysis of the user's state sequences reveals whether the patterns of activity unfolded in a coherent, systematic fashion or in a disordered, chaotic fashion. The coherent, systematic pattern of activity indicates a degree of mastery over the software, and the disordered, chaotic pattern of activity indicates a novice state or confused state with the interface features. Metrics capturing these observations can be used to evaluate the effectiveness of a particular tool and its ease of adoption by new users. Moreover, given the standardization of the activity state-space, different user sessions with the tool would be comparable on these metrics, as would sessions originating from different users.

In some implementations, the reporting module 124 can generate time-series visualizations representing the sequence of states through which each user passed. In some implementations, the reporting module 124 can output categorical distributions indicating the content of states as relative observation probability for each software activity within a state. In some implementations, the reporting module 124 can output the above-described state-space representations of all states discovered by BP-HMM and whether a given user was observed in those states.

In some implementations, the same library of activity codes used to log a user's interaction with multiple software products enables the direct quantitative comparisons between different software products.

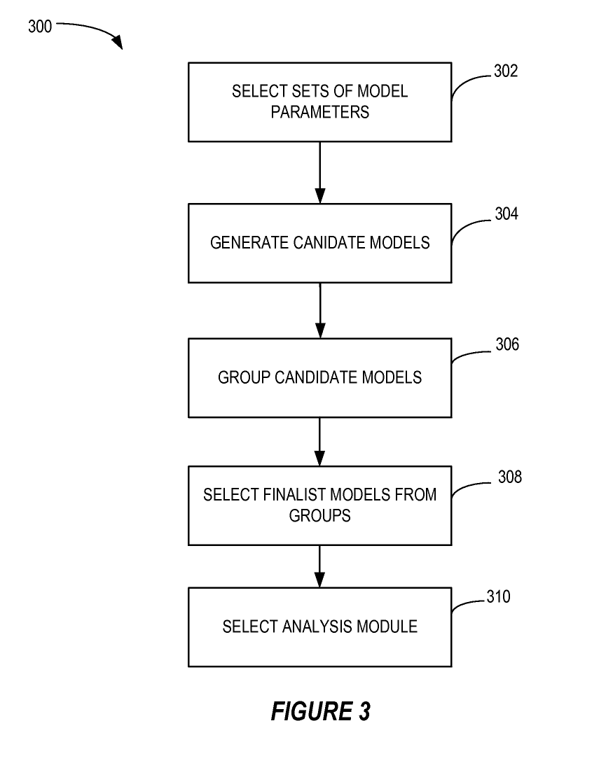

FIG. 2 is a block diagram of an example BP-HMM analysis module 200 suitable for use as the analysis module 122 shown in FIG. 1. The BP-HMM analysis module 200 includes a model parameter selection module 202, a model generation module 204, and a model selection module 206. The functionality of each of the aforementioned modules is described further below in relation to FIG. 3.

FIG. 3 is a flow diagram of an example method 300 for generating a BP-HMM that can be carried out by the BP-HMM analysis module 200. The method 300 includes selecting sets of model parameters (stage 302), generating candidate models for selected parameter sets (stage 304), grouping the candidate models (stage 306), selecting a finalist model from each grouping (stage 308), and selecting a model for analysis (the “analysis model) from the finalist models (stage 310).

As indicated above, the method 300 for generating a BP-HMM includes selecting sets of model parameters (stage 302). The model parameters are selected by the model parameter selection module 202. BP-HMM model generation is based on four key configurable parameters. Each of these parameters influences the structure and properties of the final solution, and by tuning them appropriately, the parameters can enforce domain-specific constraints on the final solution. The parameters include γ, β, κ, and λ₀.

The total number of active features in each data sequence included in the model has a Poisson distribution. The γ parameter represents the mass parameter of that distribution. Larger values of γ increase the number of features expected to be active in each sequence. Accordingly, appropriate values of γ will vary depending on the complexity of the expected user interactions with the software.

The β parameter is a concentration parameter that controls the degree to which features are shared across sequences. Larger values of β encourage more overlap in the set of active features across sequences. In some implementations β is selected to be 1.0, though a wide range of values may be appropriate depending on the data set being analyzed.

The κ parameter is a “stickiness” parameter that governs the probability of state transitions within the model. Models generated with higher values for κ tend to have longer periods of state persistence with lower transition probabilities. Conversely, models generated with lower κ values tend to short durations within each state with greater probabilities for state transitions.

The observation probability distributions of each feature are modeled as categorical distributions. The optimization routine learns the parameters of these distributions using Bayesian non-parametric methods, which require specification of a conjugate prior for these distributions. The natural conjugate prior of a multinomial distribution is a uniform Dirichlet distribution, with a concentration hyperparameter λ₀. Smaller values of λ₀ encourage sparser categorical distributions, while larger values nudge the distribution closer to uniform. The choice of λ₀ also has an overall effect on the total number of features the modeling process generates. Conceptually, features with smoother distributions individually explain more of the data than those with more sparse distributions, thus requiring fewer total features to explain all of the data in the ensemble.

In some implementations, multiple values for each of the above-described parameters are selected at random from within pre-defined or configurable ranges. In some implementations, the ranges are selected by a system user, for example through a user interface made available by the model parameter selection module 202, based on the complexity and variety of the interactions expected to be seen with in the software. In some implementations, the number of values to select for each parameter may be equal. In some other implementations, more parameter values are selected for certain of the parameters than for others. In some implementations, all integer values included within the parameter range are selected. In some implementations, a similarly exhaustive, but less granular set of parameter values, depending on the size of the range. For example, for parameters with smaller integer value ranges, the method 300 may include selecting every other integer value (e.g., odd or even values). For parameters which can accept non-integer values, values can be selected at increments of less than 1.0. For parameters with larger value ranges, values may be selected at intervals, for example, of 5, 10, 20, 25, or 50.

After the model generation parameters are selected (stage 302), candidate models are generated for multiple sets of parameter values (stage 304). The candidate models are generated by the model generation module 204 based on data output by the activity logging module 118 and activity coding module 120 shown in FIG. 1. In some implementations, the model generation module 204 utilizes a nonparametric optimization algorithm suitable for fitting a BP-HMM Model to input time series data, such as those made available in the NPBayesHMMMatlab toolbox, an open source Matlab tool kit made available by Michael Hughes of Billings, Mont., at https://github.com/michaelchughes/NPBayesHMM, designed for the generation of Hidden Markov Models. The optimization algorithm included in the NPBayesHMMMatlab toolkit is only one example of a suitable optimization algorithm. In other implementations, other optimization algorithms can be included with in the model generation module without departing from the scope of this disclosure.

In some implementations, the optimization algorithm can be iterated a configurable number of times over the data. For example the algorithm can be iterated between about 100 and about 100,000 times. In some implementations, the algorithm is iterated on the order of 10,000 times. In some other implementations, the optimization algorithm is iterated until further iterations result in a degree of change in the model that falls below a threshold difference value. The model resulting from the final iteration for a given set of parameter values is selected as the candidate model for the parameter value set.

In some implementations, candidate models are generated for parameter value sets associated with each and every combination of selected parameter values. In some other implementations, candidate models are generated for only a subset of the possible parameter value combinations.

In practice, each candidate model generated using a different parameter value set results in a model that is at least slightly different from all other generated models. The model selection module 206 can select a final model for analysis using three stages. In the first stage, candidate models are grouped together (stage 306). In a second stage, finalist models are selected from each grouping (stage 308). In the third stage, one of the finalist models is selected to be the analysis model (stage 310).

To reduce the number of potential candidate models for selection as the analysis model, the generated candidate models are grouped together (stage 306). In some implementations, the candidate models can be grouped based on the number features they include. Candidate models can be grouped into groups associated with an single feature number (e.g., 6 features, 7 features, 12 features, etc.) or a range of feature numbers (e.g., 6. features, 9-12 features, etc.). In other implementations, models can be grouped based on other shared characteristics.

From each group of candidate models, the model selection module 206 identifies a finalist candidate model (stage 308). For groups including only a single candidate model, that model is selected as a finalist candidate for the group. In some implementations, for groups with more than candidate model, the finalist candidate models are selected according to a clustering process. In one example clustering process, for each group, the model selection module 206 collects all of the categorical observation probability distribution parameters from each model in the group. These probability distribution parameters are then clustered in a number of clusters equal to the number of features included in the models in the group. The clustering can be carried out in some implementations using a K-means clustering process using a Euclidean distance metric. For each model in the group, the model selection module 206 calculates a total distance metric equal to the sum of the distances between the categorical distribution vectors and their respective cluster centroids. The model in the group having the smallest total distance metric is selected as the finalist candidate model for the group. This process tends to identify the single model within each group that had categorical distribution parameters most similar to all of the other group members.

Once the finalist candidate models are selected for the groups of models at stage 308, a final model is selected for representing the input data (i.e., the “analysis model”) (stage 310). In some implementations, the model selection module 206 selects the analysis model by identification of a “junk” state in each of the finalist candidate models. A “junk” state, as used herein refers to a state that models noise in the data that is not accounted for by the other states in the model. A state is classified as a “junk” state if the percentage of data samples from the signal ensemble assigned to this state falls below a threshold. Accordingly, the model selection module 206 selects the finalist model with the largest number of states, where none of the states can be classified as a “junk” state (stage 310). If no finalist models are found to lack a “junk” state, the model selection module can select the finalist model in which the fewest data points in the ensemble are assigned to the junk state.

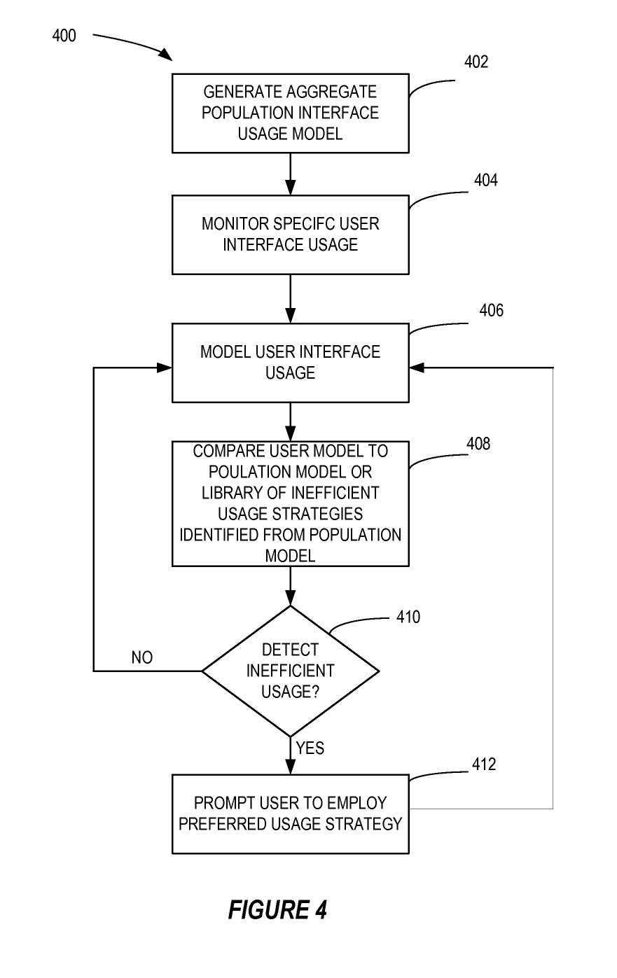

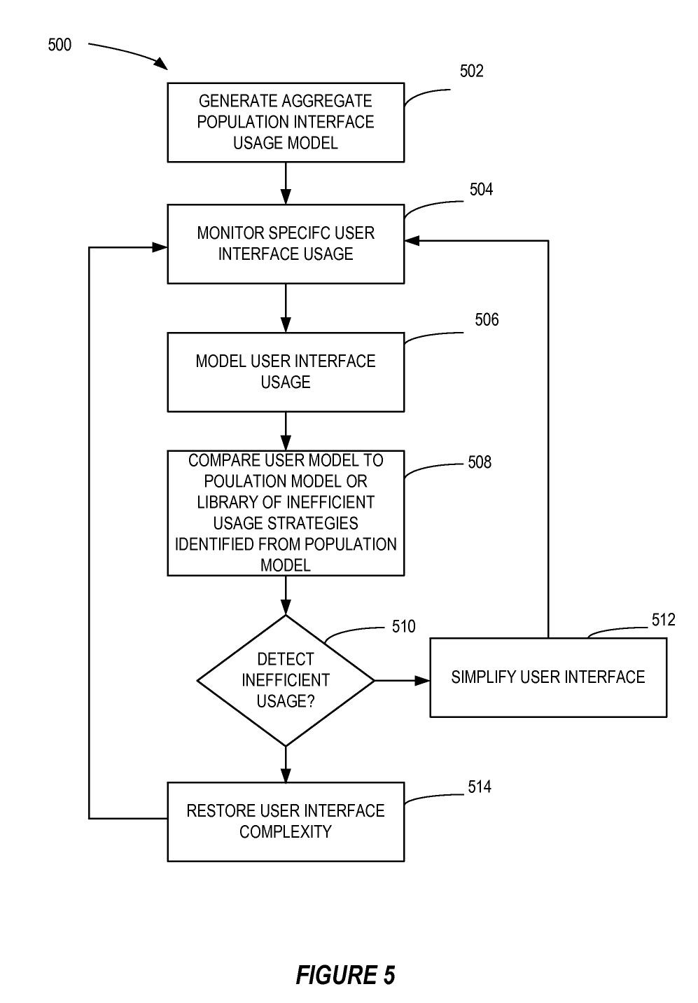

In another implementation, the HCI analysis module 116 shown in FIG. 1 enables the development and implementation of computer interfaces that adapt to or guide a user's behavior. Examples of such functionality are described further in relation to FIGS. 4 and 5.

FIG. 4 is a flow diagram of an example method of controlling user interface operation 400. The method includes generating an aggregate user population user interface usage model (stage 402), monitoring a specific user's use of the user interface (stage 404), and generating a model of the specific user's model (stage 406). The method 400 further includes comparing the model generated for the user to the model generated for the aggregate user population or to a library of inefficient usage strategies identified from the aggregate user population model (stage 408). If the comparison results in the detection of an inefficient usage strategy (at decision block 410), the method 400 includes prompting the user to employ a preferred strategy (stage 412). Each stage is discussed further below.

The method 400 includes generating an aggregate user population user interface usage model (stage 402) for a given software application. The aggregate user population user interface usage model can be generated, for example, by the analysis module 122 shown in FIG. 1 or the BP-HMM analysis module 200 shown in FIG. 2, based on the usage history of a population of users. In some implementations, the aggregation population usage model is a BP-HMM model generated according to the method 300 shown in FIG. 3. In some implementations, the usage data may be collected over time from customers who have licensed the software application and who have consented to providing such data. In some other implementations, the usage data is collected during a usability testing process carried out during the development of the software. The usage data can be collected by an activity logging module and/or an activity coding module similar to the activity logging module 118 and the activity coding module 120 shown in FIG. 1.

The usage of the software application by a specific user is then monitored (stage 404). The monitoring can be carried out by an activity logging module and/or an activity coding module similar to the activity logging module 118 and the activity coding module 120 shown in FIG. 1. The monitoring can take place during one or more training sessions with the user or during real-time day-to-day user interaction with the software application. The user's usage is modeled, for example as a BP-HMM or other model as described above (stage 406).

The individual user's usage model generated at stage 406 is then evaluated at stage (408). In some implementations, the user's usage model is compared to the model generated for the aggregate population. The comparison can yield indicia of inefficient interface usage. For example, the comparison can identify the user's usage resulting in a statistically abnormal number of state transitions, state transition loops, or statistically abnormal task completion times. In some other implementations, the aggregate population usage model is analyzed, for example by the analysis module 122 shown in FIG. 1, in advance, to identify usage strategies that are inefficient. Patterns associated with such strategies are extracted from the model and stored in a library. In such implementations, the specific user usage model can be compared to the library of inefficient strategies. Accordingly, the comparison to the library can result in identification of the use of a known inefficient usage strategy.

If inefficient use of the user interface by the user is detected (decision block 410) in the comparison, the user can be prompted to alter their usage patterns (stage 412). For example, the user can be prompted to use a more efficient usage strategy. The user prompting can be carried out by the reporting module 124. For example, the reporting module 124 can provide the user with real-time prompts, tutorials, instructions, or reports regarding how to improve usage efficiency.

FIG. 5 is a flow diagram of another example method 500 of controlling user interface operation. The method 500 is similar to the method 400 shown in FIG. 4. However, instead of merely prompting the user to use a more efficient usage strategy, the method 500 includes actively modifying the user interface in response to a detection of inefficient user behavior. The method 500 includes generating an aggregate user population user interface usage model (stage 502), monitoring a specific user's use of the user interface (stage 504) and generating a model of the specific user's model (stage 506). The model further includes comparing the model generated for the user to the model generated for the aggregate user population or to a library of inefficient usage strategies identified from the aggregate user population model (stage 508). If the comparison results in the detection of an inefficient usage strategy (at decision block 510), the user interface presented to the user is simplified (stage 512), until the user's efficient improves, at which point the user interface complexity is restored (stage 514).

Stages 502—decision block 510 of the method 500 are substantially similar to the stages 402—decision block 410 of the method 400. As indicated above, the differences in the methods are included in stages 512 and 514. At stage 512, if inefficient usage strategies are detected, the user interface of the software application is simplified. For example, in some implementations, user interface icons associated with more advanced functionality may be removed. In some implementations, the text associated with menu options is expanded to provide further guidance to the user. Alternatively or in addition, additional system prompts may be displayed as pop-up bubbles or similar user interface elements to provide a user guidance as they interact with the user interface. In some implementations the transition to the simplified user interface is triggered automatically upon detection of the inefficient usage. In some other implementations, the user interface simplification is only implemented after the user has been offered and accepts the opportunity to switch to simplified user interface.

After the user interface is simplified, the user's interactions with the updated user interface are monitored, modeled, and compared to known usage characteristics and patterns (stages 504-508). Upon a determination that the user's usage strategies have become sufficiently efficient, the simplified user interface can be restored to its original form (stage 514). In some implementations, a user is first provided a prompt, for example by the reporting module 124, giving the option to maintain the simpler interface or to revert to the original interface.

In another implementation, a similar process can be used to slowly transition beginner users of a software application to more complex interactions. For example, an initial, simpler, user interface provided to a user. Upon the user demonstrating through their usage model mastery of the simpler user interface, the software application may offer the user access to more complex functionality through a more complex user interface.

The disclosed system and methods may be embodied in other specific forms without departing from the spirit or essential characteristics thereof. The forgoing implementations are therefore to be considered in all respects illustrative, rather than limiting of the invention.

1. A system for analyzing user interface usage characteristics, comprising:
an activity logging module configured to store a log of a user-initiated software activity instances associated with usage of a user interface of a software application by a plurality of users;
an analysis module configured to generate an analysis model descriptive of the user interface usage of the plurality of users, wherein the analysis model comprises a beta-phase Hidden Markov Model (“BP-HMM”);
a reporting module configured to process the generated analysis model and output data indicative of an aggregate of the plurality of users' usage of the user interface.

2. The system of claim 1, wherein the analysis module is configured to generate the analysis model by:
selecting a plurality of model parameter value sets;
generating candidate BP-HMMs for each model parameter value set; and
selecting one of the candidate BP-HMMs as the analysis model.

3. The system of claim 2, wherein selecting one of the candidate BP-HMMs comprises:
grouping the candidate BP-HMMs into a plurality of groups;
identifying one candidate model from each of the groups as a finalist model; and
selecting one finalist model as the analysis model.

4. The system of claim 3, wherein selecting the finalist model as the analysis model comprises identifying a finalist model, of the finalist models that lack a junk state, having the most states.

5. The system of claim 2, wherein the values for at least one parameter in the model parameter value sets are selected at random.

6. The system of claim 1, wherein the analysis module is further configured to compare a specific user's user interface usage patterns to the analysis model or to a library of usage patterns extracted from the analysis model that are indicative of inefficient user interface usage.

7. The system of claim 6, wherein the reporting module is further configured, in response to the comparing, to alter the complexity of the specific user's user interface to the software application.

8. The system of claim 6, wherein the reporting module is further configured, in response to the comparing, to output to the specific user a prompt indicative of more efficient user interface usage strategies.

9. A method for analyzing user interface usage characteristics, comprising:
storing a log of user-initiated software activity instances associated with usage of a user interface of a software application by a plurality of users;
generating an analysis model descriptive of the user interface usage of the plurality of users, wherein the analysis model comprises a beta-phase Hidden Markov Model (“BP-HMM”);
processing the generated analysis model; and
outputting data indicative of an aggregate of the plurality of users' usage of the user interface.

10. The method of claim 9, wherein generating the analysis model comprises:
selecting a plurality of model parameter value sets;
generating candidate BP-HMMs for each model parameter value set; and
selecting one of the candidate BP-HMMs as the analysis model.

11. The method of claim 10, wherein selecting one of the candidate BP-HMMs comprises:
grouping the candidate BP-HMMs into a plurality of groups;
identifying one candidate model from each of the groups as a finalist model; and
selecting one finalist model as the analysis model.

12. The method of claim 11, wherein selecting the finalist model as the analysis model comprises identifying a finalist model, of the finalist models that lack a junk state, having the most states.

13. The method of claim 9, further comprising comparing a specific user's user interface usage patterns to the analysis model or to a library of usage patterns extracted from the analysis model that are indicative of inefficient user interface usage.

14. The method of claim 13, further comprising, in response to the comparing, altering the complexity of the specific user's user interface to the software application.

15. The method of claim 13, further comprising, in response to the comparing, outputting to the specific user a prompt indicative of more efficient user interface usage strategies.

16. A non-transitory computer readable storage medium storing processor executable instructions, the processor executable instructions comprising instructions for:
storing a log of user-initiated software activity instances associated with usage of a user interface of a software application by a plurality of users;
generating an analysis model descriptive of the user interface usage of the plurality of users, wherein the analysis model comprises a beta-phase Hidden Markov Model (“BP-HMM”);
processing the generated analysis model; and
outputting data indicative of an aggregate of the plurality of users' usage of the user interface.

17. The non-transitory computer readable storage medium of claim 16, further storing processor executable instructions for generating the analysis model by:
selecting a plurality of model parameter value sets;
generating candidate BP-HMMs for each model parameter value set; and
selecting one of the candidate BP-HMMs as the analysis model.

18. The non-transitory computer readable storage medium of claim 17, further storing processor executable instructions for selecting one of the candidate BP-HMMs by:
grouping the candidate BP-HMMs into a plurality of groups;
identifying one candidate model from each of the groups as a finalist model; and
selecting one finalist model as the analysis model.

19. The non-transitory computer readable storage medium of claim 18, further storing processor executable instructions for selecting the finalist model as the analysis model by identifying a finalist model, of the finalist models that lack a junk state, having the most states.

20. The non-transitory computer readable storage medium of claim 16, further storing processor executable instructions for comparing a specific user's user interface usage patterns to the analysis model or to a library of usage patterns extracted from the analysis model that are indicative of inefficient user interface usage.

21. The non-transitory computer readable storage medium of claim 20, further storing processor executable instructions for, in response to the comparing, altering the complexity of the specific user's user interface to the software application.

22. The non-transitory computer readable storage medium of claim 20, further storing processor executable instructions for, in response to the comparing, outputting to the specific user a prompt indicative of more efficient user interface usage strategies.
